(19) United States
(12) Patent Application Publication
(10) Pub. No.: US 2025/0178243 A1
(43) Pub. Date: Jun. 5, 2025

(54) Mold locking mechanism for hydraulic press

(71) Applicant: Changzhou City Cheng Xin Environmental Protection Technology Co., Ltd., Changzhou city (CN)

(72) Inventors: Tzung-shen LAI, Changzhou city (CN); Shih-Ping Wei, CHangzhou city (CN)

(21) Appl. No.: 18/527,243

(22) Filed: Dec. 2, 2023

(51) Int. Cl. B29C 33/30; B29C 33/20; B29C 43/32; B29C 43/36

(52) U.S. Cl. CPC B29C 33/305; B29C 33/20; B29C 43/36; B29C 2043/3283; B29C 2043/366

(57) ABSTRACT

A mold locking mechanism for a hydraulic press contains: a bottom plate through which a pull stud is inserted. The pull stud includes a shank and multiple defining rings, and the bottom plate further includes a clamper and a drive device. The clamper includes a pair of rotatable arms. At least one resilient element is defined between the pair of rotatable arms. When the clamper is in a clamping state, the at least one resilient element forces the pair of rotatable arm to move close to each other, and a respective one defining ring does not pass across a gap of the pair of rotatable arms. The drive device drives the pair of rotatable arms to rotate to switch the clamper to be in an unclamping state. The respective one defining ring moves across the gap after the pair of rotatable arms move away from each other.

### TECHNICAL FIELD

The present invention relates to a mold locking mechanism for a hydraulic press.

### BACKGROUND

Referring to FIGS. 7-10, a conventional hydraulic press contains a fixing plate 9, a mold holder 91, and a mold locking mechanism. The mold locking mechanism includes a cylinder 92 mounted on a top of the fixing plate 9, and the cylinder 92 has a limiting sheet 93 disposed on a actuation segment 921 thereof, an U-shaped groove 94 formed on an end of the limiting sheet 93 away from the cylinder 92, a through orifice 90 defined on the fixing plate 9, a pull stud 95 fixed on the top of the fixing plate 9 after inserting through the through orifice 90, wherein the pull stud 95 includes a shank 96 and multiple defining rings 97 separately fitted on the shank 96.

Referring to FIGS. 8-9, the limiting sheet 93 is configured to change to a first position or a second position. When the mold holder 91 is moved upward to a desired height and position, the cylinder 92 moves forward via the limiting sheet 93 so that the shank 96 enters into the U-shaped groove 94, as shown in FIG. 9, at least one defining ring 97 is fixed on the limiting sheet 93. When the limiting sheet 93 is located on a first position and a hydraulic system of the hydraulic press has a leakage, the mold holder 91 crawls or drops. Since the at least one defining ring 97 on the at least one limiting sheet 93 do not pass through the U-shaped groove 94, the mold holder 91 does not drop to cause an accident. The cylinder 92 moves rearward by driving the limiting sheet 93 so that the shank 96 removes from the U-shaped groove 94, as shown in FIG. 8, the limiting sheet 93 is located on the second position, and the mold holder 91 moves upward and downward reciprocately.

However, the conventional hydraulic press has defects as follows: when the limiting sheet 93 is located on the first position and the mold holder 91 crawls or drops to actuate the pull stud 95 to move downward, one defining ring 97 presses the limiting sheet 93, so the limiting sheet 93 cannot be switched to the second position, and the mold holder 91 is driven to actuate the pull stud 95 to move upward so that the one defining ring 97 is removed from the limiting sheet 93, and the cylinder 92 drives the limiting sheet 93 to switch to the second position, and a switch is pressed manually to control the mold holder 91 to move upward, but an upward moving distance of the mold holder 91 is not controlled accurately. When the upward moving distance of the mold holder 91 is excessive, the other defining ring 97 below the limiting sheet 93 moves upward to hit the defining sheet 93, thus breaking the limiting sheet 93.

The present invention has arisen to mitigate and/or obviate the afore-described disadvantages.

### SUMMARY

The primary aspect of the present invention is to provide a mold locking mechanism for a hydraulic press which is capable of enhancing using safety and reducing damage rate.

To obtain above-mentioned aspect, a mold locking mechanism for a hydraulic press provided by the present invention contains: a bottom plate.

A pull stud is inserted through the bottom plate, and the pull stud includes a shank and multiple defining rings separately fitted on the shank, a top face of a respective one defining ring is a conical surface, and the bottom plate further includes a clamper and a drive device. The clamper includes a pair of rotatable arms intersected on a top of the bottom plate, two front sections of the pair of rotatable arms are located beside the pull stud, and at least one resilient element is defined between two rear sections of the pair of rotatable arms.

When the clamper is in a clamping state, the at least one resilient element forces the two front sections of the pair of rotatable arms to move close to each other, and the respective one defining ring of the pull stud does not pass across a gap of the two front sections of the pair of rotatable arms.

The drive device drives the pair of rotatable arms to rotate so that the clamper is switched to be in a unclamping state, and the respective one defining ring of the pull stud moves across the gap of the two front sections of the pair of rotatable arms after the pair of rotatable arms move away from each other.

### BRIEF DESCRIPTION OF THE DRAWINGS

FIG. 1 is a perspective view showing the operation of a mold locking mechanism for a hydraulic press according to a preferred embodiment of the present invention.

FIG. 2 is another perspective view showing the operation of the mold locking mechanism for the hydraulic press according to the preferred embodiment of the present invention.

FIG. 3 is a perspective view showing the exploded components of the mold locking mechanism for the hydraulic press according to the preferred embodiment of the present invention.

FIG. 4 is a top plan view of FIG. 1.

FIG. 5 is a top plan view of FIG. 2.

FIG. 6 is a cross sectional showing the application of the mold locking mechanism for the hydraulic press according to the preferred embodiment of the present invention.

FIG. 7 is a perspective view showing the exploded components of a conventional mold locking mechanism.

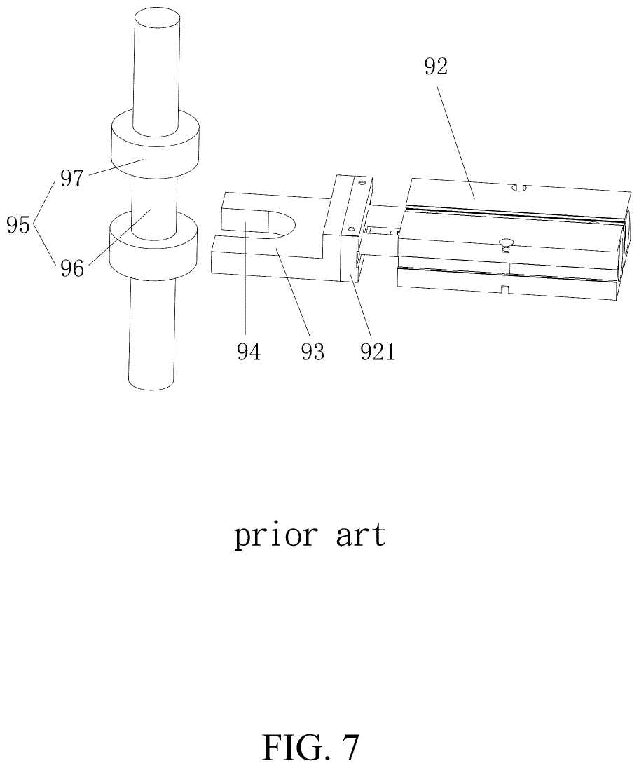

FIG. 8 is a side plan view showing the operation of the conventional mold locking mechanism.

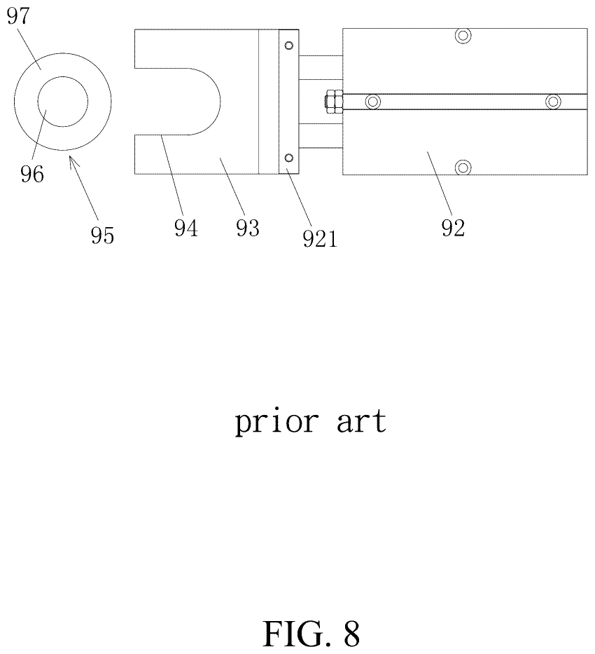

FIG. 9 is another side plan view showing the operation of the conventional mold locking mechanism.

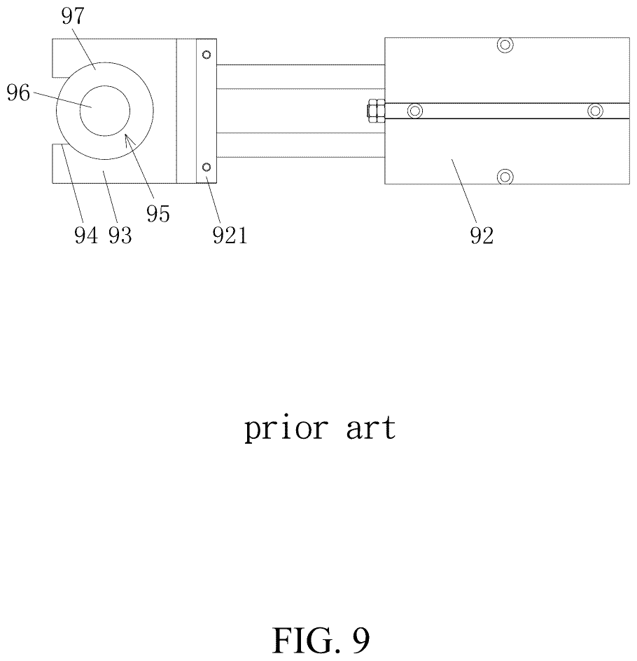

FIG. 10 is a cross sectional showing the assembly of a conventional hydraulic press.

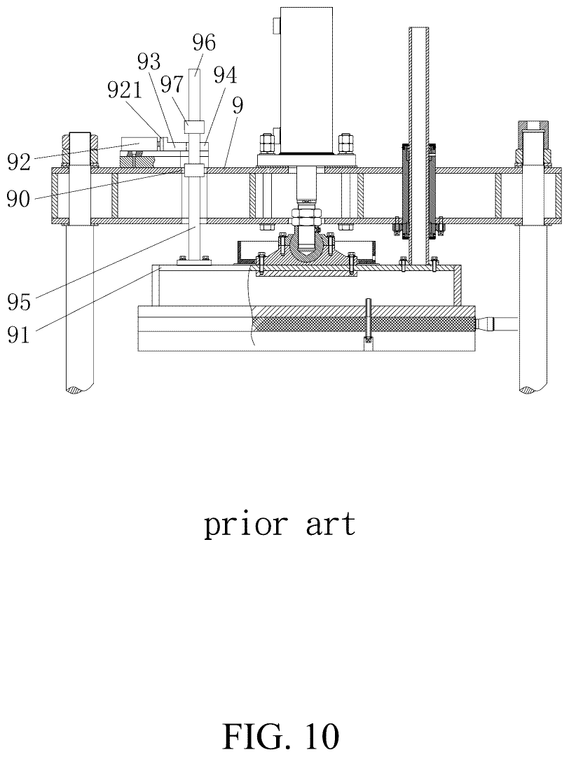

### DETAILED DESCRIPTION

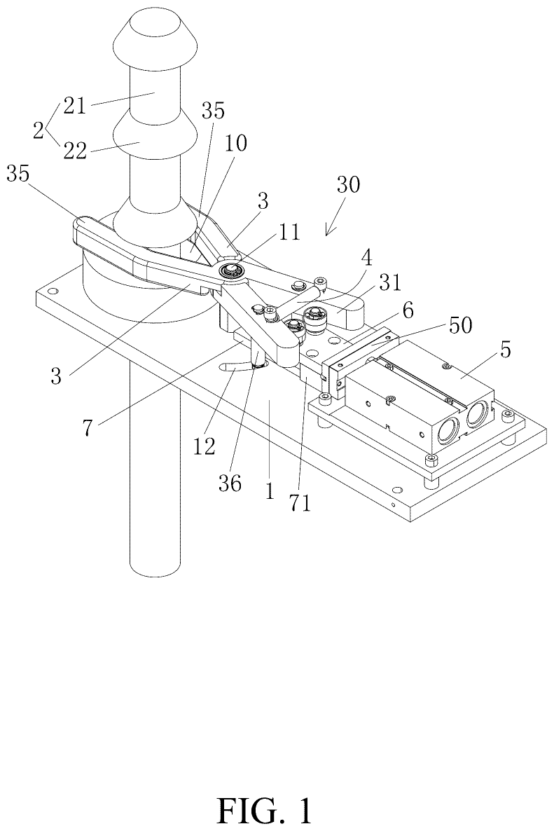

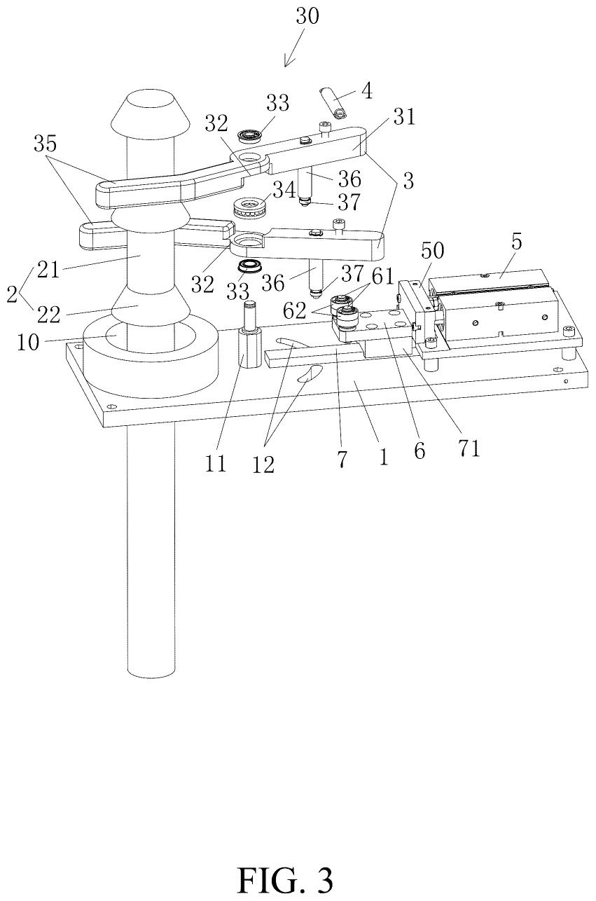

With reference to FIGS. 1-5, a mold locking mechanism for a hydraulic press 8 according to a preferred embodiment of the present invention comprises: a bottom plate 1, a through orifice 10 defined on the bottom plate 1, and a pull stud 2 inserted through the through orifice 10, wherein the pull stud 2 includes a shank 21 and multiple defining rings 22 separately fitted on the shank 21. The bottom plate 1 further includes a clamper 30 and a drive device 5, wherein the clamper 30 includes a pair of rotatable arms 3 intersected on a top of the bottom plate 1, two front sections of the pair of rotatable arms 3 are located beside the pull stud 2, and at least one resilient element 4 is defined between two rear sections of the pair of rotatable arms 3, wherein the at least one resilient element 4 is a returning spring and is configured to urge the clamper 30 to unclamp and clamp, wherein in an original state, the clamper 30 is in a clamping state. The at least one resilient element 4 is a rubber band.

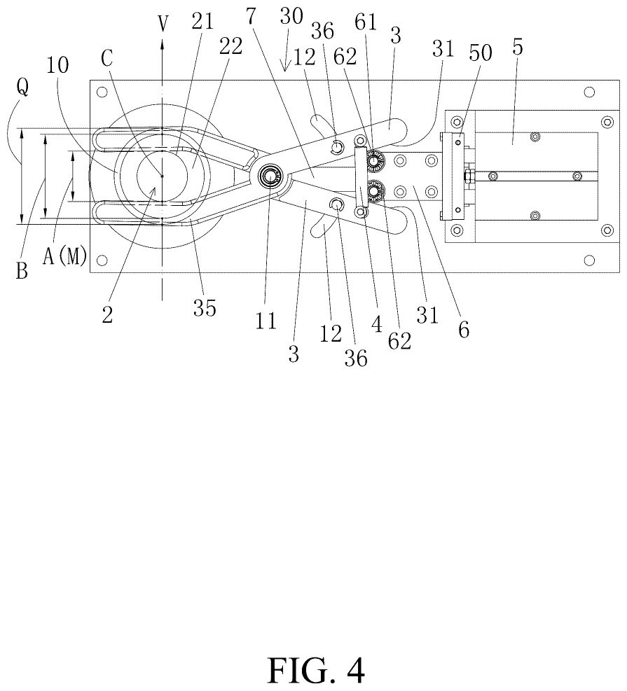

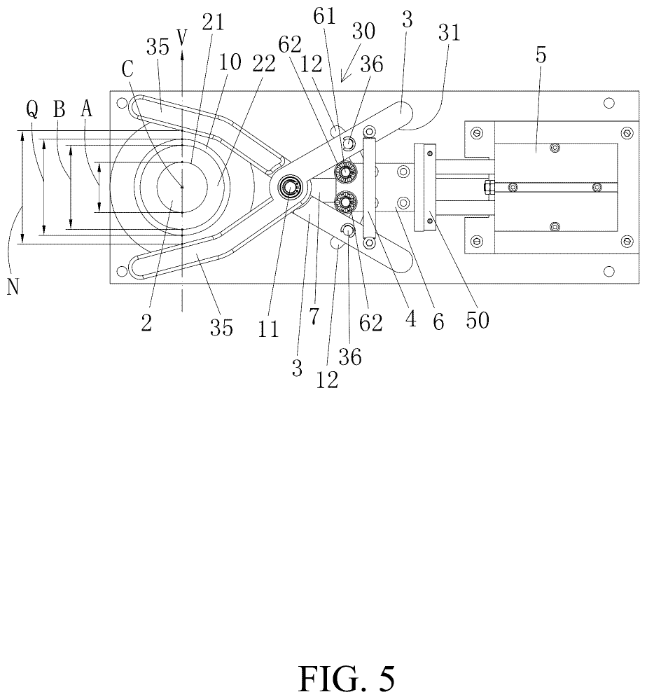

FIGS. 4 and 5 are a top plan view of the mold locking mechanism, wherein the through orifice 10 of the bottom plate 1 is circular, a central point C of the through orifice 10 is a datum point from which a virtual longitudinal axis V extends, a diameter A of the shank 21 of the pull stud 2 and a diameter B of a respective one defining ring 22 are smaller than a diameter of the through orifice 10, i.e., A<Q, B<Q.

The drive device 5 is mounted on the bottom plate 1 and is located on a rear end of the clamper 30, the drive device 5 includes a fixing plate 6 disposed on a front end of an actuation segment 50 of the drive device 5, and the bottom plate 1 includes at least one guide rail 7, wherein the fixing plate 6 is slidably arranged on the at least one guide rail 7 via a slider 71, and the fixing plate 6 includes two locating posts 61 extending from two sides thereof, wherein the fixing plate 6 also includes two first bearings 62 fitted on the two locating posts 61.

The drive device 5 is a cylinder, and the actuation segment 50 of the drive device 5 pushes the fixing plate 6 so that the two first bearings 62 of the fixing plate 6 abut against and push two internal faces 31 of the two rear sections of the pair of rotatable arms 3 to drive the pair of rotatable arms 3 to rotate. Since a rolling friction generates among the two first bearings 62 and the pair of rotatable arms 3, the pair of rotatable arms 3 have little wear and tear to prolong a service life. The drive device 5 is a screw-nut mechanism configured to push the two internal faces 31 of the two rear sections of the pair of rotatable arms 3 to drive the pair of rotatable arms 3 to rotate. In another embodiment, the drive device 5 is any one of a crank-slider mechanism, a hydraulic cylinder, and a cam mechanism. In this embodiment, the drive device 5 is the cylinder to reduce a cost.

A fixing shaft 11 is defined between the drive device 5 and the through orifice 10 of the bottom plate 1 and is configured to rotatably connect with the pair of rotatable arms 3, wherein a second bearing 33 is defined between a respective one rotatable arm 3 and the fixing shaft 11, the pair of rotatable arms 3 include two recesses 32 so that one rotatable arm 3 is engaged with the other rotatable arm 3 by using the two recesses 32. A ball bearing 34 is defined between the pair of rotatable arms 3 and is fitted on the fixing shaft 11 so that the pair of rotatable arms 3 rotate flexibly in accurately.

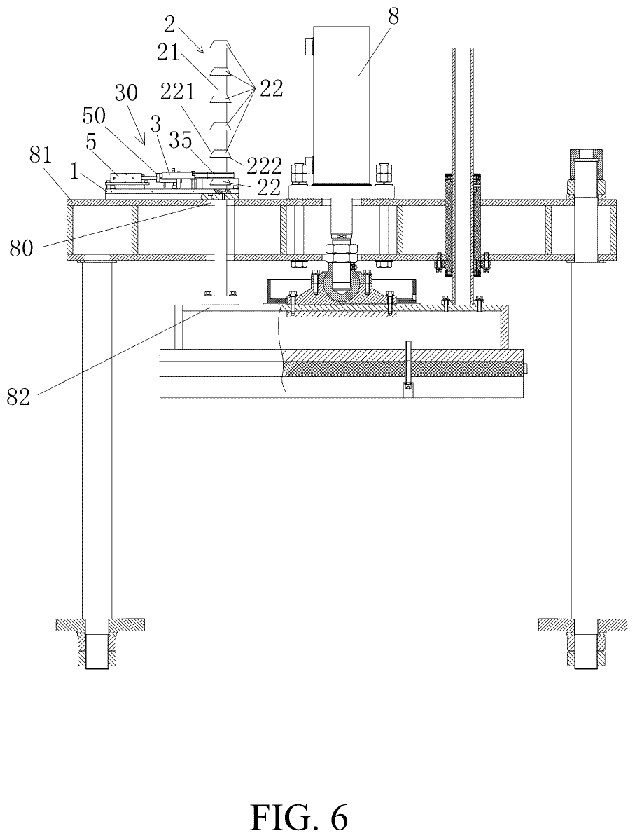

As shown in FIG. 6, a top face 221 of the respective one defining ring 22 of the pull stud 2 is a conical surface, and a bottom face 222 of the respective one defining ring 22 is a plane. In other words, a diameter of a cross section of the respective one defining ring 22 is decreased upward from the bottom face 222 of the respective one defining ring 22, wherein a number of the multiple defining rings is multiple so that the mold locking mechanism comprises multiple clamping positions to comply with various using requirements.

The respective one rotatable arm 3 includes a tilted extension 35 formed on a front section thereof so that a contact area of a respective one tilted extension 35 and the bottom face 222 of the respective one defining ring 22 is increased since the respective one tilted extension 35 is oblique, thus enhancing a support capacity of the pull stud 2. In the original state, the at least one resilient element 4 defined between the two rear sections of the pair of rotatable arms 3 forces the two tilted extensions 35 on the two front sections of the pair of rotatable arms 3 to move close to each other, wherein the two tilted extensions 35 are parallel to each other. The respective one rotatable arm 3 further includes a guiding rod 36 extending downward from a rear end thereof to the bottom plate 1, wherein at least one third bearing 37 is fitted on a distal end of the guiding rod 36 of the respective one rotatable arm 3 and is received in an arcuate orifice 12 of the bottom 1 so that the respective one rotatable arm 3 rotates accurately.

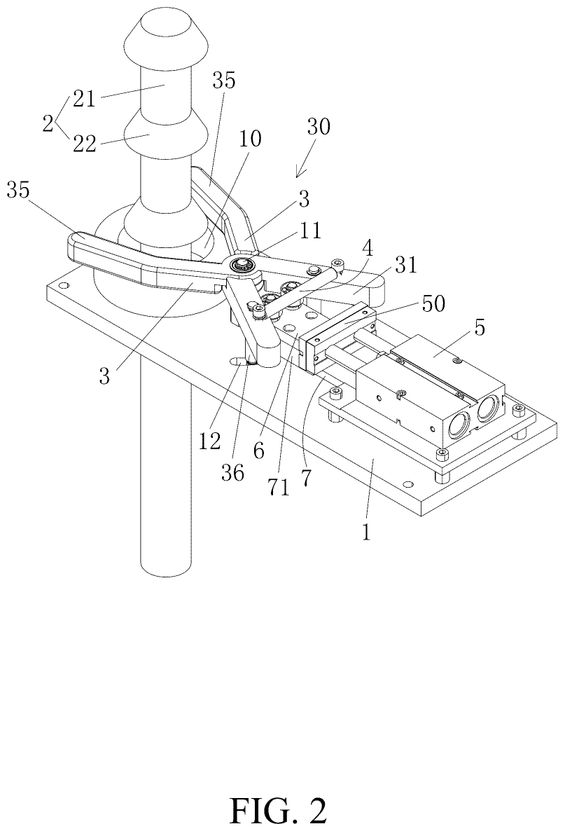

The clamper 30 is configured to clamp or unclamp a workpiece (not shown). In the original state, as shown in FIGS. 1 and 4, the clamper 30 is in the clamping state, wherein the at least one resilient element 4 forces the two tilted extensions 35 of the two front sections of the pair of rotatable arm 3 to move close to each other. In this clamping state, a gap M of the two tilted extensions 35 on the virtual longitudinal axis V is smaller than the diameter B of the respective one defining ring 22 of the pull stud 2, and the gap M is equal to the diameter A of the shank 21 of the pull stud 2, i.e., M<B, and M=A, wherein the respective one defining ring 22 of the pull stud 2 does not pass across the gap M of the two tilted extensions 35 of the pair of rotatable arms 3 in the clamping state. With reference to FIGS. 2 and 5, the actuation segment 50 of the drive device 5 pushes the fixing plate 6 so that the two first bearings 62 of the fixing plate 6 abut against and push the two internal faces 31 of the two rear sections of the pair of rotatable arms 3 to drive the pair of rotatable arms 3 to rotate, thus switching the clamper 30 to be in an unclamping state. In other words, the two tilted extensions 35 of the pair of rotatable arms 3 are spaced from each other so that a gap N of the two tilted extensions 35 on the virtual longitudinal axis V is larger than the diameter B of the respective one defining ring 22 of the pull stud 2, i.e., N>B. Also, When the pair of rotatable arms 3 are spaced from each other, the gap N of the two tilted extensions 35 on the virtual longitudinal axis V is larger than a diameter Q of the through orifice 10 of the bottom plate 1, i.e., N>Q, such that the respective one defining ring 22 of the pull stud 2 passes across the gap N of the two tilted extensions 35 of the pair of rotatable arms 3, when the pair of rotatable arms 3 are spaced from each other.

Referring to FIG. 6, the mold locking mechanism is mounted on a hydraulic press 8, the bottom plate 1 of the mold locking mechanism is fixed on a support plate 31 of the hydraulic press 8, and a bottom of the pull stud 2 of the mold locking mechanism is disposed on a mold holder 82 of the hydraulic press 8, such that the mold holder 82 of the hydraulic press 8 actuates the pull stud 2 to move upward and downward reciprocately. When the clamper 30 is in the clamping state, the mold holder 82 of the hydraulic press 8 drops downward and actuates the pull stud 2 to move downward. In the meantime, the bottom face 222 of one defining ring 22 abuts against and presses the pair of rotatable arms 3 so that the drive device 5 does not drive the clamper 30 to switch to a unclamping state by using the actuation segment 50, the mold holder 82 of the hydraulic press 8 drives the pull stud 2 to move upward so that the one defining ring 22 removes from the pair of rotatable arm 3, and the actuation segment 50 of the drive device 5 drives the clamper 30 to be in the unclamping state. Thereby, when the mold holder 82 of the hydraulic press 8 is manually controlled to move upward by pressing a switch, an upward moving distance of the mold holder 82 is not controlled easily.

When the upward moving distance of the mold holder 82 is excessive, the one defining ring 22 below the pair of rotatable arms 3 moves upward to hit the pair of rotatable arms 3. Due to the top face 221 of the respective one defining ring 22 is the conical surface, the two tilted extensions 35 of the pair of rotatable arms 3 slide across the top face 221 of the respective one defining ring 22 and move away from each other, during the one defining ring 22 hits the pair of rotatable arms 3. Accordingly, after the two tilted extensions 35 of the pair of rotatable arms 3 are hit by the one defining ring 22, the pair of rotatable arms 3 are not broken.

The hydraulic press 8 includes a passing hole 80 defined on a locating sheet 81 thereof, and a bottom of the pull stud 2 is fixed on the mold holder 82 of the hydraulic press 8 via the passing hole 80.

In use, the actuation segment 50 of the drive device 5 drives the clamper 30 to be in the unclamping state, and when the mold holder 82 of the hydraulic press 8 actuates the pull stud 2 to move upward and downward reciprocately and moves upward to a desired height and position, the clamper 30 is switched to be in the clamping state. Since the at least one defining ring 22 is located above the clamper 30, when a hydraulic system of the hydraulic press 8 produces a leakage and the mold holder 82 of the hydraulic press 8 drops downward, the bottom face 222 of the one defining ring 22 above the clamper 30 abuts against and presses the pair of rotatable arms 3, hence the one defining ring 22 of the pull stud 2 does not pass across the gap M of the two tilted extensions 35 of the pair of rotatable arms 3, as illustrated in FIG. 4. Accordingly, the mold holder 82 of the hydraulic press 8 does not drop continuously to cause unsafety or accident. A tensile strength of the pull stud 2 is so high enough that the mold locking mechanism sustains larger loading, for example, the tensile strength of the pull stud 2 is applicable for with the hydraulic press 8 with a large tonnage to obtain using safety and to reduce a damage rate.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A mold locking mechanism for a hydraulic press comprising: a bottom plate;
wherein a pull stud is inserted through the bottom plate, and the pull stud includes a shank and multiple defining rings separately fitted on the shank, a top face of a respective one defining ring is a conical surface, and the bottom plate further includes a clamper and a drive device, wherein the clamper includes a pair of rotatable arms intersected on a top of the bottom plate, two front sections of the pair of rotatable arms are located beside the pull stud, and at least one resilient element is defined between two rear sections of the pair of rotatable arms;
wherein when the clamper is in a clamping state, the at least one resilient element forces the two front sections of the pair of rotatable arms to move close to each other, and the respective one defining ring of the pull stud does not pass across a gap of the two front sections of the pair of rotatable arms; and
wherein the drive device drives the pair of rotatable arms to rotate so that the clamper is switched to be in a unclamping state, and the respective one defining ring of the pull stud moves across the gap of the two front sections of the pair of rotatable arms after the pair of rotatable arms move away from each other.

2. The mold locking mechanism as claimed in claim 1, wherein the bottom plate further includes a through orifice defined thereon, and the pull stud is inserted through the through orifice, wherein a central point of the through orifice is a datum point from which a virtual longitudinal axis extends, and a diameter of the shank of the pull stud and a diameter of the respective one defining ring are smaller than a diameter of the through orifice.

3. The mold locking mechanism as claimed in claim 1, wherein the at least one resilient element is a returning spring and is configured to urge the clamper to unclamp and clamp.

4. The mold locking mechanism as claimed in claim 1, wherein the drive device is mounted on the bottom plate and is located on a rear end of the clamper, the drive device includes a fixing plate disposed on a front end of a actuation segment of the drive device, and the bottom plate includes at least one guide rail, wherein the fixing plate is slidably arranged on the at least one guide rail via a slider, and the fixing plate includes two locating posts extending from two sides thereof, the fixing plate also includes two first bearings fitted on the two locating posts; the drive device is a cylinder, and the actuation segment of the drive device pushes the fixing plate so that the two first bearings of the fixing plate abut against and push two internal faces of two rear sections of the pair of rotatable arms to drive the pair of rotatable arms to rotate, wherein a rolling friction generates among the two first bearings and the pair of rotatable arms.

5. The mold locking mechanism as claimed in claim 2, wherein a fixing shaft is defined between the drive device and the through orifice of the bottom plate and is configured to rotatably connect with the pair of rotatable arms, wherein a second bearing is defined between a respective one rotatable arm and the fixing shaft, the pair of rotatable arms include two recesses so that one rotatable arm is engaged with the other rotatable arm by using the two recesses; and ball bearing is defined between the pair of rotatable arms and is fitted on the fixing shaft.

6. The mold locking mechanism as claimed in claim 1, wherein a bottom face of the respective one defining ring is a plane, and a diameter of a cross section of the respective one defining ring is decreased upward from the bottom face of the respective one defining ring.

7. The mold locking mechanism as claimed in claim 6, wherein the respective one rotatable arm includes a tilted extension formed on a front section thereof so that a contact area of a respective one tilted extension and the bottom face of the respective one defining ring is increased since the respective one tilted extension is oblique, thus enhancing a support capacity of the pull stud; wherein in an original state, the at least one resilient element defined between the two rear sections of the pair of rotatable arms forces the two tilted extensions on the two front sections of the pair of rotatable arms to move close to each other, wherein the two tilted extensions are parallel to each other.

8. The mold locking mechanism as claimed in claim 1, wherein the respective one rotatable arm further includes a guiding rod extending downward from a rear section of the respective one rotatable arm to the bottom plate, wherein at least one third bearing is fitted on a distal end of the guiding rod of the respective one rotatable arm and is received in an arcuate orifice of the bottom.

9. The mold locking mechanism as claimed in claim 2, wherein in a clamping state, a gap of the two tilted extensions on the virtual longitudinal axis is smaller than the diameter of the respective one defining ring of the pull stud, and the gap is equal to the diameter of the shank of the pull stud; when the pair of rotatable arms are spaced from each other, a gap of the two tilted extensions on the virtual longitudinal axis is larger than the diameter of the respective one defining ring of the pull stud; and when the pair of rotatable arms are spaced from each other, a gap of the two tilted extensions on the virtual longitudinal axis is larger than a diameter of the through orifice of the bottom plate.

10. The mold locking mechanism as claimed in claim 1, wherein the bottom plate of the mold locking mechanism is fixed on a support plate of the hydraulic press, and the hydraulic press includes a passing hole defined on a locating sheet thereof, and a bottom of the pull stud is fixed on the mold holder of the hydraulic press via the passing hole, wherein the mold holder of the hydraulic press actuates the pull stud to move upward and downward reciprocately.
